(19) United States
(12) Patent Application Publication
(10) Pub. No.: US 2025/0233853 A1
(43) Pub. Date: Jul. 17, 2025

(54) DEVICE MANAGEMENT APPARATUS, CONTROL METHOD OF DEVICE MANAGEMENT APPARATUS, AND STORAGE MEDIUM

(71) Applicant: CANON KABUSHIKI KAISHA, Tokyo (JP)

(72) Inventor: TOSHIYUKI NAKAZAWA, Tokyo (JP)

(21) Appl. No.: 18/969,399

(22) Filed: Dec. 5, 2024

(30) Foreign Application Priority Data
Jan. 11, 2024 (JP) 2024-002865

(51) Int. Cl. H04L 9/40

(52) U.S. Cl. CPC H04L 63/0442

(57) ABSTRACT

A device management apparatus managing key pairs set in management target network devices via a network receives a selection as to whether or not to perform overwriting with a key pair instructed to be added to a network device if a key pair for the same usage as the usage of the key pair instructed to be added has already been set in the network device, and deletes the same usage as that of a key pair instructed to be added from the usage of the key pair set in the network device and adds the key pair instructed to be added if a selection to perform overwriting with the key pair instructed to be added has been received.

### BACKGROUND OF THE INVENTION

### Field of the Invention

The present invention relates to a device management apparatus managing key pairs set in network devices, a control method of a device management apparatus, and a storage medium.

### Description of the Related Art

For example, in the related art, there are techniques of managing key pairs of devices in which a device generates a key pair by itself and the key pair is utilized. Japanese Patent Laid-Open No. 2005-303676 discloses a technology in which it is judged whether or not key pair data is present in a device when a power source of the device starts up and a key pair is automatically generated and saved if no key pair data is present. In addition, regarding another technique of managing key pairs of devices, Japanese Patent Laid-Open No. 7208707 discloses a technology in which a key pair is requested with respect to an authentication station and a key pair received from the authentication station is saved and utilized.

However, if a device generates a key pair by itself as in Japanese Patent Laid-Open No. 2005-303676, a generated key pair is a self-signed certificate and verification of the certificate will fail. For example, if a key pair generated by a device itself is utilized as a certificate for an HTTPS server, a web browser displays a warning indicating that the connection is not safe. In addition, as in Japanese Patent Laid-Open No. 7208707, if a key pair is requested with respect to an authentication station, it is necessary to prepare an authentication station for receiving a request for a key pair from a device, which becomes a burden on a client. In addition, if a key pair has a usage, such as TLS communication, signature, or authentication of IPSec or IEEE 802.1X, it is necessary to separately designate these usages. If a usage is designated for a key pair, there is a restriction that only one key pair is present for this usage at all times, and keys cannot be added or deleted.

### SUMMARY OF THE INVENTION

The present invention improves convenience in managing key pairs in which a usage managed in a device is designated.

A device management apparatus of the present invention manages key pairs set in management target network devices via a network. A device management apparatus comprising: a memory storing instructions; and a processor executing the instructions causing the device management apparatus to: receive a selection as to whether or not to perform overwriting with a key pair instructed to be added to a network device if a key pair for the same usage as the usage of the key pair instructed to be added has already been set in the network device; and delete the same usage as that of a key pair instructed to be added from the usage of the key pair set in the network device and add the key pair instructed to be added if a selection to perform overwriting with the key pair instructed to be added has been received.

Further features of the present invention will become apparent from the following description of exemplary embodiments with reference to the attached drawings.

### BRIEF DESCRIPTION OF THE DRAWINGS

FIG. 1 is a view showing an overall constitution of a network device management system.

FIG. 2 is a view showing a hardware constitution of a device management server.

FIGS. 3A and 3B are views showing software constitutions of the device management server and an agent.

FIG. 4 is a view showing an example of a key pair management screen provided by the device management server.

FIG. 5 is a view showing an example of a key pair registration screen provided by the device management server.

FIG. 6 is a view showing an example of a setting screen for linking between a key pair and a device.

FIG. 7 is a view showing an example of a setting screen for adding a key pair to a device.

FIG. 8 is a flowchart showing processing of adding a key pair to a device.

FIG. 9 is a flowchart showing the processing of adding a key pair to a device.

FIG. 10 is a flowchart showing processing of creating a list of key pairs to be registered and a list of key pair differences.

FIG. 11 is a view showing an example of a setting screen for deleting a key pair from a device.

FIG. 12 is a flowchart showing processing of deleting a key pair from a device.

FIG. 13 is a flowchart showing the processing of deleting a key pair from a device.

FIG. 14 is a flowchart showing integration processing of a list of key pairs.

### DESCRIPTION OF THE EMBODIMENTS

### First Embodiment

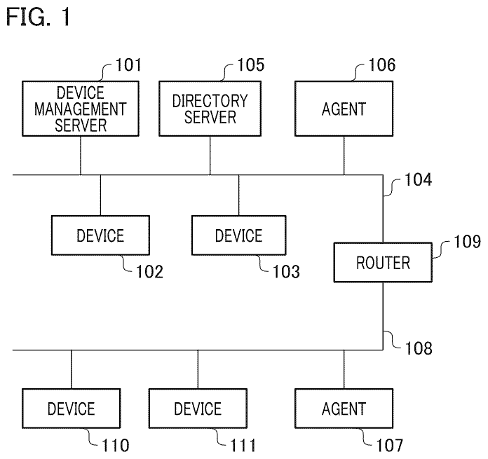

FIG. 1 is an explanatory view of an overall constitution of a network device management system. The network device management system (which will hereinafter be referred to as a device management system) provides a service (function) to network devices via a network. If there are a large number of devices to be managed, the device management system may be constituted of a management apparatus performing overall management, and a plurality of agents executing processing with respect to the devices in response to an instruction of the management apparatus. The device management system of the present embodiment has one device management application server and a plurality of agent application devices.

A device management server 101 is a device management apparatus having a device management application. The device management application provides a function for managing management target devices. An agent 106 and an agent 107 are agent devices having an agent application. That is, the device management system of the present embodiment has one device management server 101, and the agent 106 and the agent 107 serving as a plurality of agent application devices. The device management system manages network devices, such as a device 102, a device 103, a device 110, and a device 111. The agents and the network devices are linked together in accordance with addresses or the like of the devices. For example, the agent 106 is linked to the devices 102 and 103, and the agent 107 is linked to the devices 110 and 111. In the present embodiment, two agents and four devices will be described as an example. However, even if tens of thousands of devices are managed via around ten agents, the constitution and the operation are similar to those in the description of the present embodiment.

In addition, the device management system may include a directory server 105. The directory server 105 is an information processing device which manages user information such as accounts of users. The device management server 101 and the directory server 105 are connected to each other by a network 104. The device management server 101 can also perform settings such that users of the directory server 105 can log in as users of the device management server 101.

The device management server 101, the directory server 105, the agent 106, the device 102, and the device 103 are connected to each other by the network 104. For example, the network 104 is a WAN. The agent 107, the device 110, and the device 111 are connected to each other by a network 108. For example, the network 108 is a LAN. The network 104 and the network 108 are connected by a router 109. For example, the router 109 can also be constituted to permit communication between the device management server 101 and the agent 107 on the network 108 but block communication between the device management server 101, and the device 110 and the device 111.

In the present embodiment, a case in which the network 104 is a WAN and the network 108 is a LAN will be described as an example. However, the network 104 and the network 108 need only be constituted such that data can be transmitted and received, and any communication method may be used. For example, each network is constituted by any of a LAN, a WAN, a cellular network such as LTE or 5G, a wireless network, a telephone line, a dedicated digital line, and the like, or a combination of these.

In the present embodiment, it is assumed that the device management server 101 communicates with the device 102 and the device 103 via the agent 106. In addition, it is assumed that the device management server 101 communicates with the device 110 and the device 111 via the router 109 and the agent 107. In the present embodiment, an example in which the device management server 101 and the agent 106 are operated by different hosts will be described. However, the device management server 101 and the agent 106 can also be operated on the same host. If the device management server 101 and the agent 106 are operated on the same host, the device 102 and the device 103 can directly communicate with the device management server 101.

The device management server 101 provides various kinds of services (functions) to management target network devices. The device management server 101 of the present embodiment provides services to the network devices utilizing the agents. Examples of services provided by the device management server 101 include services for managing key pairs of the network devices. In addition, in the device management server 101, a web service server related to functions provided by a host device is built into the host device. In addition to one or a plurality of information processing devices, the device management server 101 may be realized by a virtual machine (cloud service) utilizing a resource provided by a data center including information processing devices, or a combination of these. In addition to one or a plurality of information processing devices, the directory server 105 may also be realized by a virtual machine (cloud service) utilizing a resource provided by a data center including information processing devices, or a combination of these. In addition, the device management system can be used as a web-based application and can also be utilized via a web browser in a PC.

The agent 106 and the agent 107 are agent devices performing communication with devices on the basis of an instruction of the device management server 101. A web service server related to the functions provided by the device management server 101 is built into the agent 106 and the agent 107. In addition, the agents are linked to the network devices in accordance with addresses or the like of the network devices. The agent 106 is linked to the device 102 and the device 103. The agent 107 is linked to the device 110 and the device 111.

The device 102, the device 103, the device 110, and the device 111 are management targets of the device management server 101 and are network devices capable of communicating with the device management server 101. For example, the network devices are multi-function printers (MFP) in which a plurality of functions such as a printing function, a reading function, and a FAX function are integrated. The network devices may be printers, scanner devices, image forming devices such as 3D printers, information processing devices such as PCs, image processing devices such as cameras, smart home appliances, or the like. The network devices can perform encrypted communication with an external device such as the device management server 101 and have an HTTPS server function. A key pair of a public key and a secret key for encrypting communication is set in the network devices of the present embodiment. A key pair set in a device includes a default key which is managed such that it cannot be deleted from the device. In addition, a usage can be set in a key pair. It is also possible to set no usage in a key pair.

Here, a flow of processing of performing provision of services to the network devices by the network device management system will be described with the agent 106 and the device 102 as an example. The device management server 101 instructs the agent 106 to operate the device 102. In response to an instruction of the device management server 101, the agent 106 performs an operation, such as transmission of a request to the device 102, and transmits results to the device management server 101. Examples of operations of the agent 106 with respect to the device 102 include acquisition of information from the device 102, change of set values of the device 102, issuance of an instruction to install an application in the device 102, and issuance of an instruction to change settings of the key pair of the device 102. In this manner, communication is performed between the device management server 101 and the agent 106 and between the agent 106 and the device 102. For this reason, the device 102 and the device management server 101 do not directly communicate with each other.

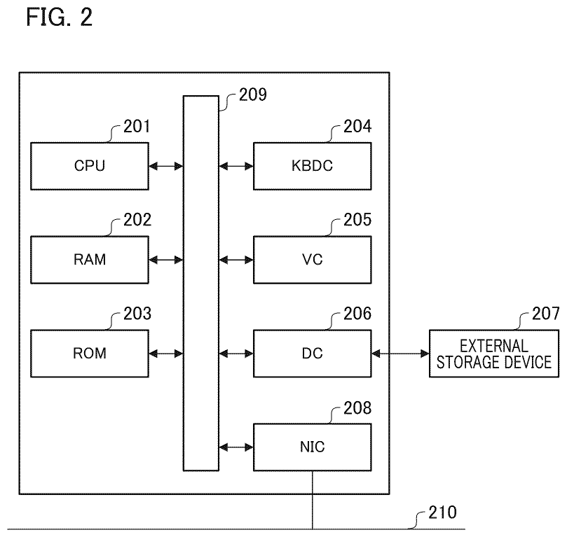

FIG. 2 is an explanatory view of a hardware constitution of the device management server 101. In addition, a host computer in which the agent 106, the agent 107, and the directory server 105 operate also has a hardware constitution similar to that of the device management server 101. The device management server 101 includes a CPU 201, a RAM 202, a ROM 203, a KBDC 204, a VC 205, a DC 206, and an NIC 208. These constituent elements are connected to a system bus 209.

The CPU 201 controls the device management server 101 in its entirety. The CPU 201 loads a program stored in a memory (the ROM 203 or an external storage device 207) in the RAM 202 and executes it as necessary, thereby generally controlling each of the units connected to the system bus 209. In addition, the CPU 201 may generally control each of the units connected to the system bus 209 by loading software (program) downloaded via the network in the RAM 202 and executing it as necessary. The random access memory (RAM) 202 is a memory capable of reading and writing data and functions as a main memory, a work area, or the like of the CPU 201. The read only memory (ROM) 203 is a memory dedicated to reading data and stores a basic control program and the like of the device management server 101, for example. The external storage device 207 is a memory such as a hard disk (HD) or a solid-state drive (SSD). The external storage device 207 stores a booting program, an operating system (OS), an authentication server, various kinds of applications including an authentication client and the like, database data, a user file, and the like.

The KBDC 204 controls an input to the device management server 101. The KBDC 204 sends information input using an input device, such as a keyboard or a pointing device (not shown), a virtual keyboard, audio, or the like to the CPU 201 and controls an input to the device management server 101. The VC 205 is a video controller and controls display on a display device (not shown). For example, the display device may be a liquid crystal display (LCD) or may be a head-mounted display or the like capable of displaying virtual reality (VR). The DC 206 is a disk controller and controls access to the external storage device 207. The NIC 208 is a communication controller, and the device management server 101 is connected to the network 104 via the NIC 208. The CPU 201 is connected to the network 104 via the NIC 208 and enables data communication with each device on the network.

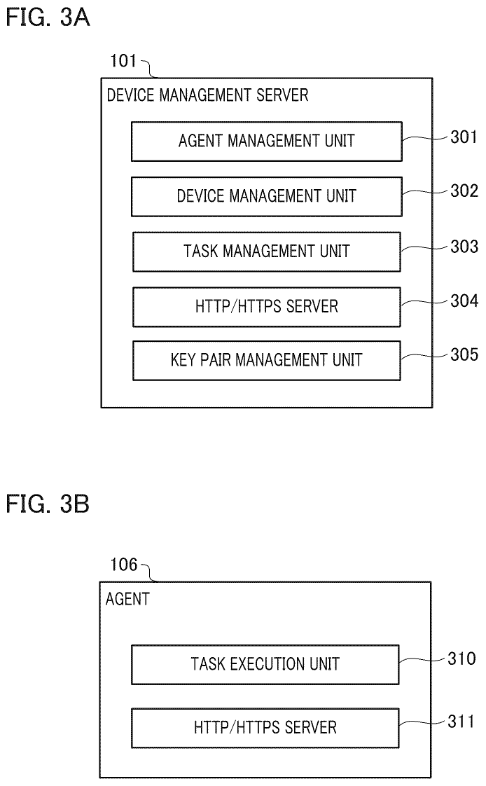

FIGS. 3A and 3B are views showing software constitutions of the device management server and an agent. FIG. 3A is an explanatory view of the software constitution of the device management server 101. The device management server 101 realizes processing by the functional module shown in FIG. 3A when the CPU 201 calls an application program for device management from the memory and executes it. For example, the functional module shown in FIG. 3A is provided as a device management application.

The device management server 101 has an agent management unit 301, a device management unit 302, a task management unit 303, an HTTP/HTTPS server 304, and a firmware management unit 305. The agent management unit 301 manages information related to the agent 106 and the agent 107. The device management unit 302 manages information related to the device 102, the device 103, the device 110, and the device 111. Information related to the devices includes information regarding the agents to which the devices are linked. The task management unit 303 performs management of tasks. Regarding management of tasks, the task management unit 303 manages details and results of operations with respect to the devices. In addition, the task management unit 303 instructs the agents to perform operations with respect to the devices through execution of tasks. Management information managed by the task management unit 303 is stored in a database (not shown).

The device management server 101 has both an HTTP function and an HTTPS function. The HTTP/HTTPS server 304 is a web service server built into the device management server 101 and is related to the services provided by the device management server 101. The HTTP/HTTPS server 304 receives requests from external devices such as the agents and the devices and returns responses to the requests. In addition, the HTTP/HTTPS server 304 provides a WEB UI for a user to operate the device management server 101. The key pair management unit 305 performs management of key pairs in the devices and key pairs set in the devices.

FIG. 3B is an explanatory view of the software constitution of the agent. Here, the agent 106 will be described as an example. However, other agents also have a similar constitution. The agent 106 realizes processing by the functional module shown in FIG. 3B when the CPU 201 calls an application program for a device management agent from the memory and executes it. The functional module shown in FIG. 3B is a functional module related to the service provided by the device management server 101 and is provided as an agent application provided from the device management server 101, for example.

The agent 106 has a task execution unit 310 and an HTTP/HTTPS server 311. The task execution unit 310 executes tasks instructed by the device management server 101. The task execution unit 310 executes operations with respect to the devices in response to an instruction of the device management server 101 and then transmits results to the device management server 101. The HTTP/HTTPS server 311 is a web service server built into the agent 106 and is related to the services provided by the device management server 101. The HTTP/HTTPS server 311 receives requests from external devices such as the device management server 101 and the devices. The device management server 101 and the agent 106 communicate with each other mainly using HTTPS via the HTTP/HTTPS server 304 of the device management server 101 and the HTTP/HTTPS server 311 of the agent 106.

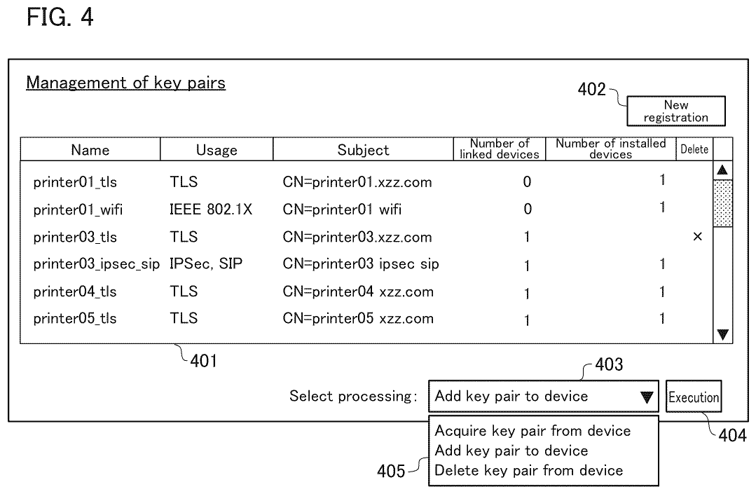

FIG. 4 is a view showing an example of a key pair management screen provided by the device management server 101. For example, the key pair management screen includes a table 401, a new registration button 402, a drop-down list 403, and an execution button 404. The table 401 is a table displaying a list of registered key pairs in the device management server 101. For example, the table 401 includes items of Name, Usage, Subject, Number of linked devices, Number of installed devices, and Delete. “Name” indicates names given to key pairs by a user. “Usage” indicates usages designated for key pairs. Each key pair secures its uniqueness by a combination of “Name”, “Usage”, and a key pair body.

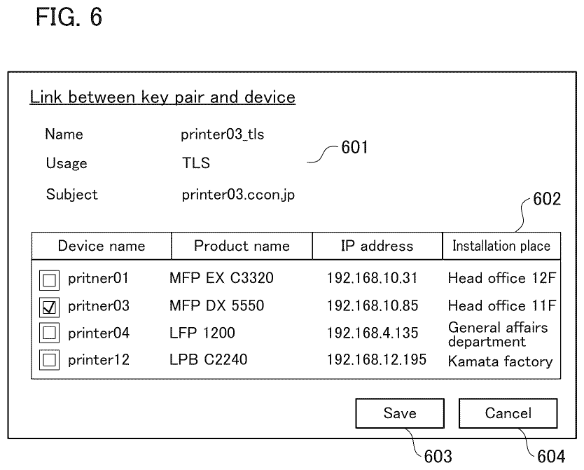

The table 401 also includes key pairs which are acquired from the device 102, the device 103, the device 110, and the device 111 and registered in respective devices. “Number of linked devices” in the table 401 displays the numbers of linked devices for registration of key pairs. When a user's click on the cell of “Number of linked devices” in a row within the table is detected, the device management server 101 shifts to a screen for setting a link between the key pair and the device in the clicked row (FIG. 6). “Number of installed devices” in the table 401 indicates the numbers of devices in which the key pair is registered. When a user's click on the cell of “Number of installed devices” in a row within the table is detected, the device management server 101 displays a list of devices in which the key pair in the clicked row is registered (not shown).

In “Delete”, deletable key pairs are displayed in a recognizable manner. The deletable key pairs are key pairs which are not registered in the devices (that is, “Number of installed devices” is zero). In the example shown in FIG. 4, an “x” mark is displayed in the item of Delete as a delete button for the deletable key pairs. On the other hand, if a key pair has been registered in a device (that is, if “Number of installed devices” is one or larger), the device management server 101 does not display the delete button

When a user's click on the cell of “x” in a row within the table 401 is detected, the device management server 101 displays a dialog box for confirming deletion of the key pair in the clicked row. Further, when a user's instruction to perform deletion is confirmed, the device management server 101 deletes the key pair from the device management server 101.

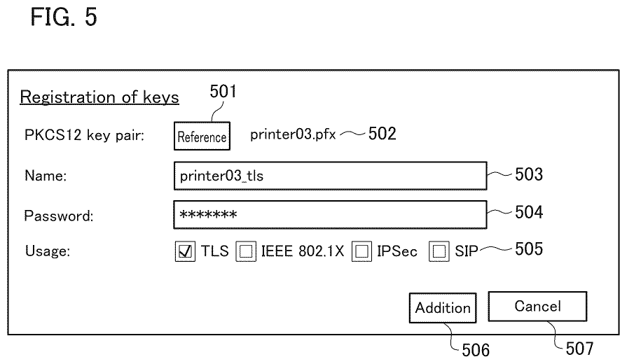

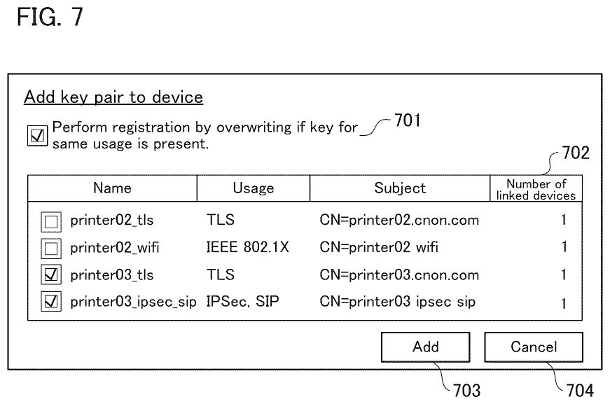

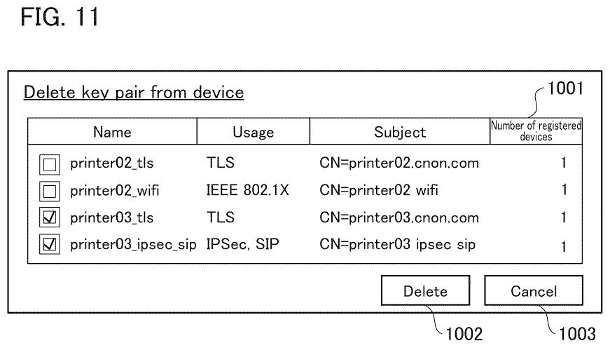

The new registration button 402 is a button for registering a key pair. When a click on the new registration button 402 is detected, the device management server 101 shifts to a screen for registering a key pair in the device management server 101, which will be described below (FIG. 5). The drop-down list 403 is a drop-down list for selecting processing. An option 405 indicates options for the drop-down list 403. For example, the options for the drop-down list 403 include “Acquire key pair from device”, “Add key pair to device”, and “Delete key pair from device”. A user selects desired processing in the drop-down list 403 and presses down the execution button 404. When a click on the execution button 404 is detected, the device management server 101 executes processing corresponding to the processing selected in the drop-down list 403. If “Acquire key pair from device” is selected, the device management server 101 acquires information of the key pair registered in the device, saves the results in a database or a file system within the device management server 101, and updates display of the table 401. If “Add key pair to device” is selected, the device management server 101 opens a setting screen for processing of adding a key pair to a device as shown in FIG. 7. If “Delete key pair from device” is selected, the device management server 101 opens a setting screen for processing of deleting a key pair from a device as shown in FIG. 11.

FIG. 5 is a view showing an example of a key pair registration screen provided by the device management server 101. When it is detected that the new registration button 402 is pressed down, the device management server 101 displays the key pair registration screen shown in FIG. 5. In the key pair registration screen, a key pair to be added to a device is registered in the device management server 101. Here, a case in which a key pair is registered in the device 102 will be described as an example. For example, the key pair registration screen includes a reference button 501, a file name 502, a name 503, a password 504, a usage 505, an addition button 506, and a cancel button 507.

The reference button 501 is a button for designating a file storing key pair data saved in the host computer. For example, the key pair data is stored in the file in a PKCS #12 format. The format of the key pair data is not limited to the PKCS #12 format. When the reference button 501 is clicked, a dialog box for selecting a file provided by the OS or the web browser opens. A user selects a file name corresponding to the key pair data in the displayed dialog box. The file name 502 is a file name including the key pair selected by clicking the reference button 501. In the example shown in FIG. 5, the key pair having the file name 502 of “printer03.pfx” is designated as a registration target.

The name 503 is a text box for inputting the name of the key pair. The name of the key pair is used by the device management server 101 and the device 102 as information for a user to identify the key pair. The password 504 is a text box for inputting a password of the key pair in the PKCS #12 format shown in the file name 502. The usage 505 is a checkbox for designating a usage of the key pair to be added within the device 102. Here, a plurality of checkboxes can be selected. Regarding the usage 505 of the key pair in the device 102, for example, “TLS”, “IEEE 802.1X”, “IPSec”, and “SIP” can be selected. The usage of the key pair is not limited to this. The key pair for the usage “Transport layer security (TLS)” is a key pair of the server used if the device has the HTTPS server function. The HTTPS server function of the device uses TLS as a communication protocol and uses the key pair for the usage TLS in TLS communication. The key pair for the usage “IEEE 802.1X” is a key pair used in an IEEE 802.1x authentication function. The key pair for the usage “Security architecture for Internet protocol (IPSec)” is a key pair used in encrypted communication of IPSec. The key pair for the usage “Session initiation protocol (SIP)” is a key pair used in encrypted communication of SIP. In the example shown in FIG. 5, the checkbox for “TLS” is checked as the usage 505.

The addition button 506 is a button for additionally registering a key pair designated by a user in the key pair registration screen in the device management server 101. If the file name 502, the input name 503, and the input password 504 are valid, the device management server 101 makes the addition button 506 valid. Even when the usage 505 is not designated, a key pair can be registered. When a user's click on the addition button 506 is detected, the device management server 101 checks the details input in the key pair registration screen. Specifically, the device management server 101 checks whether the key pair file in a PKCD #12 format indicated by the file name 502 is a valid key pair and whether the password of the key pair file matches the password input to the password 504. If the result of checking is correct, the device management server 101 saves the key pair data of the file name 502 together with the name 503, the password 504, and the usage 505 in the database or the file system within the device management server 101. Further, when registration of the key pair is completed, the device management server 101 shifts to the key pair management screen shown in FIG. 4. On the other hand, if the result of checking is not correct, for example, if the key pair file is invalid or if the password does not match, the device management server 101 displays a dialog box indicating an error, and no key pair is registered. When a user's click on the cancel button 507 is detected, the device management server 101 shifts to the key pair management screen shown in FIG. 4.

FIG. 6 is a view showing an example of a setting screen for linking between a key pair and a device provided by the device management server 101. When the device management server 101 detects a click on the cell of “Link” in a row within the table 401 in the key pair management screen (FIG. 4), the device management server 101 displays a link setting screen. The link setting screen is a screen for managing settings of a link between the key pair selected in the key pair management screen and the network device. For example, the link setting screen includes key pair information 601, a table 602, a save button 603, and a cancel button 604.

The key pair information 601 is an area displaying information related to a link target key pair. For example, the key pair information 601 displays the name, the usage, and the subject of a key pair. The table 602 is a table for selecting a device to be linked to the key pair. For example, the table 602 displays a checkbox and device information. For example, the device information includes the device name, the product name, the IP address of the device, and the installation place of the device. A user designates a device to be linked to the key pair by selecting the checkbox in the table 602.

When a user's click on the save button 603 is detected, the device management server 101 links the device whose checkbox in the table 602 is selected to the link target key pair displayed in the key pair information 601 and saves it in the database. When a user's click on the cancel button 604 is detected, the device management server 101 shifts to the key pair management screen shown in FIG. 4.

Data for the device management server 101 and the device 102 to exchange information of the key pair is constituted of a file group which is compressed and integrated using ZIP or TAR, for example. The file group is constituted of a configuration file (for example, an XML file or a JSON file) in which information of the key pair is described, and a directory storing files in which each piece of the key pair data is converted into the PKCS #12 format. Hereinafter, an example of a key configuration file for the device 102 will be described.

```
<?xml version=″1.0″?>
<device_configuration xmlns=″http://www.my.company.com/ns/
deviceConfiguration″>
  <configuration_settings>
<password>X′78B0851086BA1A9A8741903A515A085D07D17A8A915
2B44D44BB1D27C7DD0B877A′</password>
  </configuration_settings>
  <key_management_settings>
    <key>
      <device_default_key usage=″1″ />
      <device_keys>
        <device_key name=″printer03_TLS_key″ usage=″1″>
          device_key_file_01.p12
        </device_key>
        <device_key name=″printer03_wifi_key″ usage=″2″>
          device_key_file_02.p12
        </device_key>
      </device_keys>
    </key>
  </key_management_settings>
</device_configuration>
```

Password information of the configuration file is stored in “password” of “configuration_settings” of the configuration file. Confidential information in the configuration file is encrypted using information generated from this password. In addition, the password of the configuration file is a password of the file in the PKCD #12 format of the key pair included in configuration data. For example, the password information of the configuration file is a value calculated from a hash of the password such that the password cannot be guessed from the configuration file.

The key in the device 102 is constituted of one default key pair which is automatically generated by the device 102, and a plurality of key pairs which are registered by a user. The key_management_settings block includes the usage of the default key pair (usage device_default_key) and information of the plurality of key pairs (device_keys) registered by a user. The default key is a key pair which is stored in the device from the time of factory shipment of the device and is managed such that it cannot be deleted. For this reason, the default key is always present in the device.

Each key pair registered by a user includes the name of the key pair (device_key name) and the usage of the key pair (usage) set by the user as attributes, and the file name of the key pair data as a value. For example, the usage is indicated by 4 bits, and the presence or absence of a usage is allocated for each of the four digits. The digits respectively denote the following usages.
First digit=0001=1=TLS
Second digit-0010=2=IEEE 802.1X
Third digit=0100=4=IPSec
Fourth digit=1000=8=SIP

For example, “4” (0100 in binary) denotes “IPSec”, and “10” (1010 in binary) denotes “IEEE 802.1X” and “SIP”. In addition, regarding the usage of a key, there are following restrictions.
1. The same usage cannot be assigned to a plurality of key pairs including the default key pair.
2. It is necessary for the key pair for the usage TLS to be always present.

Therefore, the key pair for the usage TLS is a key pair for a predetermined usage that has to be always present in a network device.

When the device management server 101 requests acquisition of information of the key pair registered in the device 102 to the device 102, the device 102 performs processing of the information of its own key pair into data in the format described above and replies it to the device management server 101. When data of information of the key pair in the foregoing format is received from the device management server 101, the device 102 verifies the details of the received data. Further, if the results of verification show no problem, registration information of the key pair inside the device 102 is updated with the details of the data received from the device 102. Although it is not described in detail in the present embodiment, it is natural that authentication and authorization are required when the device management server 101 calls the device 102 to acquire or set the key pair information.

FIG. 7 is a view showing an example of a setting screen for adding a key pair to a device. The setting screen for adding a key pair to a device is a screen provided by the device management server 101 for setting processing of adding the key pair registered in the device management server 101 to the device 102. When a click on the execution button 404 is detected in a state in which “Add key pair to device” is selected in the drop-down list 403 in the key pair management screen (FIG. 4), the device management server 101 displays the setting screen for adding a key pair to a device.

For example, the setting screen for adding a key pair to a device includes a checkbox 701, a table 702, an addition button 703, and a cancel button 704. In the checkbox 701, processing in the case in which a key pair for the same usage as the usage of the key pair intended to be added has already been present in the device is set. Since there is a restriction on a usage of a key that the same usage cannot be assigned to a plurality of key pairs including the default key pair, if a key pair for the same usage is added, only one of the existing key pair and the key pair to be newly added can be present therein as the key pair for the usage. Hence, in the checkbox 701, it is selected whether or not to perform registration by overwriting the existing key pair with the key pair instructed to be added if a key for the same usage is present. The device management server 101 functions as a selection unit configured to receive a selection as to whether or not to perform overwriting with the key pair to be added if the key pair for the same usage as the usage of the key pair to be added has already been set in the device 102 by detecting the ON/OFF state of the checkbox 701.

If the checkbox 701 is selected, the device management server 101 performs registration by overwriting with a key pair to be currently added. That is, the device management server 101 deletes the usage of the key pair to be added from the key pair which has already been present in the device and adds the key pair. If the checkbox 701 is not selected, the device management server 101 does not add any key pair if the key pair for the same usage as the usage of the key pair intended to be added has already been present in the device.

The table 702 displays a list of key pairs to which devices are linked. A user selects a key pair to be added from the list of key pairs to which the devices displayed in the table 702 are linked. The table 702 displays checkboxes for selecting keys, names of keys, usages, subjects, and the numbers of linked devices. A user checks checkboxes corresponding to the keys to be added. When a user's click on the addition button 703 is detected, the device management server 101 starts processing of adding the selected key pairs to respective devices linked to the key pairs whose checkbox is selected in the table 702. When a user's click on the cancel button 704 is detected, the device management server 101 closes the setting screen for adding a key pair to a device.

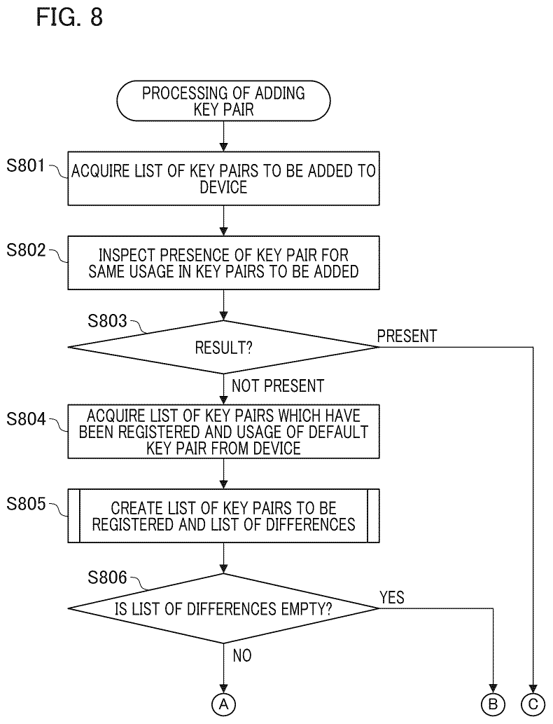

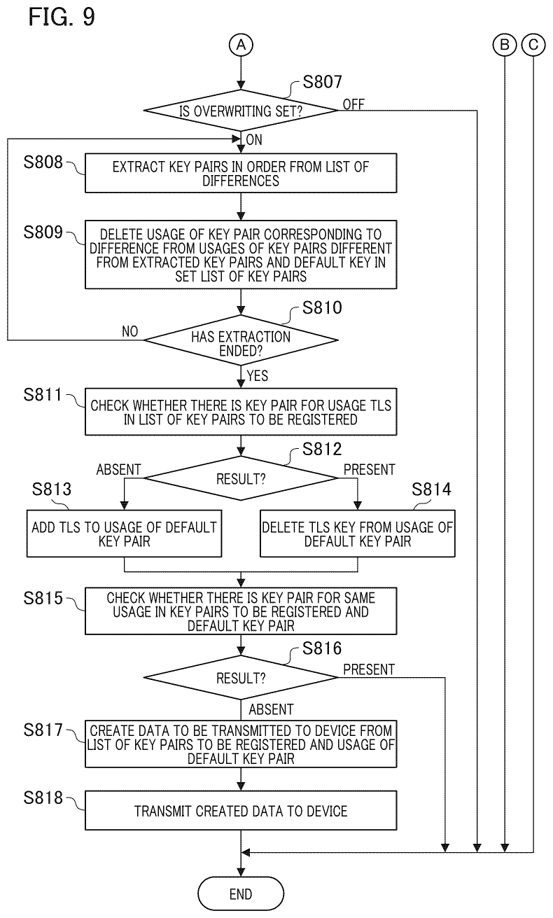

FIGS. 8 and 9 are flowcharts showing processing of adding a key pair to a device. Here, a case in which the device management server 101 adds a key pair to the device 102 will be described as an example. The processing of adding a key pair to a device by the device management server 101 is realized by the CPU 201 of the device management server 101 calling a program of the device management application from the memory (the ROM 203 or the external storage device 207) and executing it. Therefore, the CPU 201 of the device management server 101 functions as an addition unit configured to add a key pair to a device.

In Step S801, the device management server 101 acquires a list of key pairs instructed to be added to a target device. Specifically, the device management server 101 acquires key pairs linked to the target device from the key pairs designated to be added by a user and creates a list of them. In the present embodiment, the device management server 101 acquires key pairs linked to the device 102 from the key pairs selected in the setting screen for adding a key pair to a device (FIG. 7). In Step S802, the device management server 101 inspects whether a key pair for the same usage is present in the key pairs to be added. In Step S803, as the inspection results in Step S802, the device management server 101 judges whether or not a key pair for the same usage is present. As the inspection results, if a key pair for the same usage is present, the device management server 101 ends the present processing without setting a key pair in the device. The device management server 101 may display an error message indicating that a key pair for the same usage is present. As the inspection results, if a key pair for the same usage is not present, the device management server 101 performs the processing of Step S804.

In Step S804, the device management server 101 acquires registration information of the key pair of the device from the addition target device. The key pair information acquired from the device includes the usage of the default key pair and the list of registered key pairs. In the present embodiment, the device management server 101 acquires the list of key pairs which have been registered in the device 102 and the usage of the default key from the device 102.

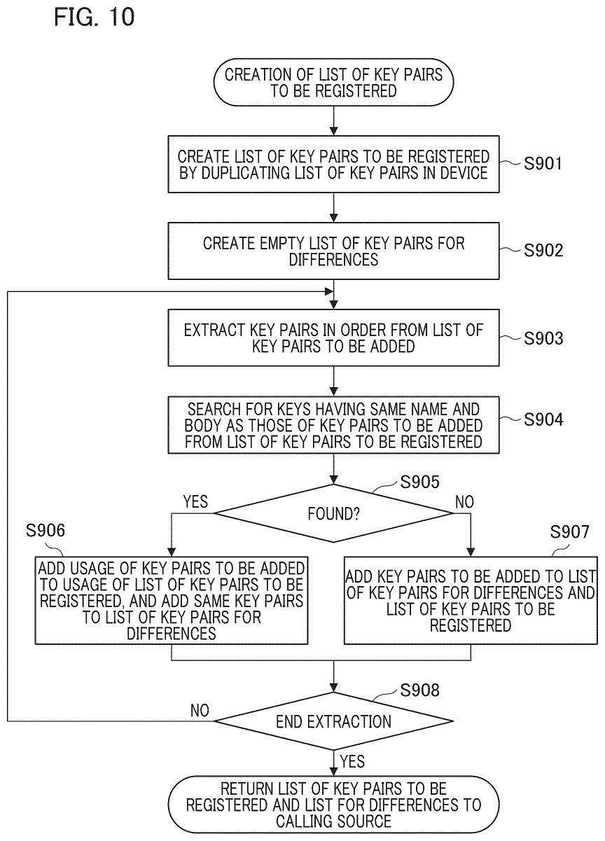

In Step S805, the device management server 101 creates a list of key pairs to be registered in the device and a list of differences between the list of key pairs to be set in this device and the list of key pairs which have been registered in the device. The list of key pairs to be registered in the device is a list of a combination of the key pairs which have been registered in the device and the key pairs which are scheduled to be added in current addition processing. Specifically, the device management server 101 creates a list of key pairs to be registered in the device from the list of key pairs instructed to be added to the device acquired in Step S801 and the list of key pairs which have been registered in the device acquired in Step S804. The list includes no default key. Further, the device management server 101 creates a list of key pair differences with the difference between the created list of key pairs to be set in the device and the list of key pairs which have been registered in the device acquired in Step S804. That is, the list of key pair differences is a list of key pairs which will be newly added to the device 102. The processing of Step S805 will be described below in detail using FIG. 10.

In Step S806, the device management server 101 judges whether or not the list of differences created in Step S805 is empty. If the list of differences is empty, this denotes that there is no key pair to be newly added, and therefore the device management server 101 ends the present processing without setting a key pair in the device. If there is a difference, that is, if the list of differences is not empty, the processing of Step S807 is performed.

In Step S807, the device management server 101 judges whether or not overwriting the usage of the key pair, in which the existing usages of the key pairs are overwritten with the usage of the key pair to be added if the key pair for the same usage as the usage of the key pair instructed to be added is set in the device, is set. The device management server 101 judges whether or not overwriting the usage of the key pair is set on the basis of settings of the checkbox 701 in the setting screen for adding a key pair to a device (FIG. 7). If the checkbox 701 is not checked, it is judged that overwriting is not set, and the device management server 101 performs the processing of Step S811. On the other hand, if the checkbox 701 is checked, it is judged that overwriting is set, and the device management server 101 performs the processing of Step S808.

There is a restriction on the usage of the key that the same usage cannot be assigned to a plurality of key pairs including the default key pair. For this reason, in a case in which overwriting the usage of the key pair is set, if the usage set in the key pair to be added is set in the key pairs which are currently registered in the device 102, it is necessary for the device management server 101 to delete the usages of the key pairs which have been registered. Hence, by repeating the processing of Step S808 and Step S809, the same usage as the usage of the key pair to be added is deleted from the usage of the key pair including the default key which has already been set in the device 102. In Step S808, the device management server 101 extracts the key pairs (key pairs corresponding to the difference) from the list of key pair differences. The key pairs in the list of key pair differences have a key pair body or a usage different from those of the key pairs which are currently registered in the device 102, and some of the usages of the key pairs which are currently registered in the device 102 are overwritten with the usages of the key pairs in the list of differences.

In Step S809, the device management server 101 deletes the same usage as the usage of the key pair corresponding to the difference extracted from the existing usages of the key pairs in Step S808. Specifically, first, the device management server 101 deletes the same usage as the usage of the key pair corresponding to the difference from the usages of the key pairs different from the key pairs corresponding to the difference extracted in Step S808 in the list of key pairs to be registered created in Step S805. Moreover, the device management server 101 deletes the same usage as the usage of the key pair corresponding to the difference from the usage of the default key. Here, the usage of the default key pair is a usage of the default key pair acquired from the device 102 in Step 804 and currently set in the device. The same usage as the usage of the key pair to be added can be deleted by deleting the same usage as the usage of the key pair corresponding to the difference from the existing usages of the key pairs.

In Step S810, the device management server 101 judges whether or not extraction of all the key pairs from the list of key pair differences has ended. If extraction of all the key pairs from the list of key pair differences has ended, the processing of Step S811 is performed. On the other hand, if extraction of all the key pairs from the list of key pair differences has not ended, the processing returns to Step S808.

Regarding the usage of the key pair, there is a key pair for a predetermined usage that has to be always present in a device. Specifically, in the present embodiment, there is a restriction that it is necessary for the key pair for the usage TLS to be always present. Hence, in Step S811, the device management server 101 judges whether there is a key pair for the usage TLS, which is a key pair for a predetermined usage that has to be always present in a device, in the list of key pairs to be registered. If a key pair for the usage TLS is not present in the list of key pairs to be registered, the device management server 101 performs the processing of Step S813. On the other hand, if a key pair for the usage TLS is present in the list of key pairs to be registered, the device management server 101 performs the processing of Step S814.

In Step S813, the device management server 101 adds the usage TLS to the usage of the default key pair. Since the usage TLS can be added to the default key through the processing of Step S813 if there is no key pair for the usage TLS in the key pairs to be registered, it is possible to comply with the restriction that it is necessary for the key pair for the usage TLS to be always present. In Step S814, the device management server 101 cancels (deletes) settings of the usage TLS from the usage of the default key pair.

In Step S815, the device management server 101 checks whether a key pair for the same usage is present in the key pairs to be registered and the default key pair. As a result of checking, if the usage overlaps, the device management server 101 ends the present processing without setting a key pair in the device. On the other hand, as a result of checking, if the usage does not overlap, the device management server 101 performs the processing of Step S817.

In Step S817, the device management server 101 creates registration instruction data of key pairs to be transmitted to the device 102 on the basis of the list of key pairs to be registered and the usage of the default key pair. Finally, in Step S818, the device management server 101 transmits the registration instruction data of key pairs created in Step S817 to the device 102. The device 102 which has received the registration instruction data of key pairs from the device management server 101 sets the key pairs of the device 102 on the basis of the received registration instruction data of key pairs. Accordingly, addition of the key pairs to the device 102 is realized while complying with the restriction related to the key pairs. With this, the processing of adding a key pair ends. After the processing of adding a key pair has ended, the device management server 101 acquires the key pair information from the device 102 and updates the list of key pairs (table 401) in the device management server 101 displayed in the key pair management screen (FIG. 4).

Here, detailed processing of Step S805 will be described using FIG. 10. FIG. 10 is a flowchart showing processing of creating a list of key pairs to be registered and a list of key pair differences. In the present processing, a list of key pairs to be registered in the device 102 and a list of key pairs to be added (a list of key pair differences) are created from the list of key pairs instructed to be added and the list of key pairs registered in the device 102. The processing of creating the list of key pairs to be registered and the list of key pair differences by the device management server 101 is realized by the CPU 201 of the device management server 101 calling the program of the device management application from the memory and executing it.

The device management server 101 acquires the list of key pairs instructed to be added to the device in Step S801 and the list of key pairs which have been registered in the device (the list of key pairs which are currently registered in the device 102) in Step S804. In Step S901, the device management server 101 duplicates the list of key pairs registered in the device and creates the list of key pairs to be registered. In the present processing, the list of key pairs to be registered is completed by adding the key pairs determined to be added through the processing of Step S903 to Step S908 to the list of key pairs to be registered which has been duplicated and created in Step S901.

In Step S902, the device management server 101 creates an empty list of key pairs for differences. In the present processing, the list of key pair differences is completed by adding the key pairs determined to be added through the processing of Step S903 to Step S908 to the empty list of key pair differences created in Step S902.

In Step S903, the device management server 101 extracts key pairs in order from the list of key pairs instructed to be added acquired in S801. In Step S904, the device management server 101 searches for key pairs whose name and body match those of the key pairs to be added extracted in S903 from the list of key pairs to be registered. In Step S905, as a result of searching in Step S904, the device management server 101 judges whether key pairs whose name and body match those of the key pairs to be added are found from the list of key pairs to be registered. If key pairs with matching name and body are found, the device management server 101 performs the processing of Step S906. On the other hand, if the key pairs with matching name and body are not found, the device management server 101 performs the processing of Step S907.

In Step S906, the device management server 101 performs settings of adding the usages of the key pairs to be added to the usages of the key pairs to be registered whose name and body match those of the key pairs to be added. Further, the device management server 101 adds the key pairs to be registered, which are subjected to settings of adding the usages, to the list of key pair differences. For example, it is assumed that the usages of the keys to be added extracted in Step S903 are “IPSec” and “SIP” and the usages of the key pairs with matching name and body found from the list of key pairs to be registered are “IEEE 802.1X” and “SIP”. “IPSec” is subjected to settings of adding to the matching usages of the key pairs in the list of key pairs to be registered, and the updated usages of the key pairs become “IEEE 802.1X”, “IPSec”, and “SIP”. That is, a union of the usages of two key pairs (keys to be added extracted in Step S903 and key pairs in the list of key pairs to be registered whose name and usage match those of the keys) is set to the usages of the key pairs to be registered. If the usages of the key pairs to be added match the usages of the key pairs to be registered whose name and body match those of the key pairs to be added, neither the usages are added nor the key pairs are added to the list of key pair differences.

In Step S907, the device management server 101 adds the key pairs to be added extracted in Step S903 to both the list of key pairs to be registered and the list of differences. This denotes that additional registration is performed because the key pairs to be added extracted in Step S903 are not currently registered in the device 102. In Step S908, the device management server 101 checks whether processing has been performed with respect to all the key pairs of the list of key pairs instructed to be added acquired in Step S801, that is, whether all the key pairs are extracted in Step S903. If processing with respect to the key pairs instructed to be added to all the devices 102 has ended, the device management server 101 performs the processing of Step S909. On the other hand, if processing with respect to the key pairs instructed to be added to all the devices 102 has not ended, the device management server 101 returns to the processing of Step S903.

In Step S909, the device management server 101 completes creation of a list of key pairs to be registered and a list of key pairs for differences and returns the created list of key pairs to be registered and the list of key pair differences to a calling source of the processing, thereby ending the present processing. If the key pairs to be added have already been present in the device and the usages also match them, the list of differences will be empty.

Through the processing of FIGS. 8 to 10, for example, addition of key pairs is executed as follows. In the following description, a thumbmark (a part of which is omitted to avoid lengthy display) is used as information for identifying the key pair body, but it is not limited thereto. For more precise identification, it is also possible to use a combination of all or some of a thumbmark, a serial number, and a subject as the information for identifying the key pair body.

### Example 1

Table 1 shows the key pairs of the device 102 before addition. Two key pairs such as a default key pair and a key pair having the name “printer03-wifi” are set in the device 102 before addition. TLS is set for the usage of the default key pair. IEEE 802.1X is set for the usage of printer03-wifi.

TABLE 1

| Name of key pair | Usage | Thumbmark of key pair |
|---|---|---|
| Default key pair | TLS | n/a |
| printer03-wifi | IEEE 802.1X | 14:06:39:81:C3:and so on |
| | | to:90:7E:FB:4D:70 |

Table 2 shows the key pair instructed to be added to the device 102. The key pair instructed to be added has the name “printer03-tls”, and TLS is set for the usage.

TABLE 2

| Name of key pair | Usage | Thumbmark of key pair |
|---|---|---|
| printer03-tls | TLS | DB:C3:AB:FA:13:and so on |
| | | to:67:ED:71:58:ED |

A case in which the key pair shown in Table 2 is instructed to be added to the device 102 in which the key pairs shown in Table 1 are set will be described. First, a case in which the checkbox 701 in the setting screen for adding a key pair to a device (FIG. 7) is set to “OFF” will be described. If a key for the same usage is present in the device, and if it is set not to perform addition, since the key pair having the usage TLS is installed for the usage of the default key pair, the device management server 101 does not perform the processing of adding a key pair. Next, a case in which the checkbox 701 in the setting screen for adding a key pair to a device (FIG. 7) is set to “ON” will be described. If the usage of the key pair to be added is prioritized when the key pair for the same usage is present in the device, since the key pair having the usage TLS and instructed to be added is added, the device management server 101 deletes TLS from the usage of the default key pair. Table 3 shows settings of the key pairs of the device 102 after the addition processing in the case in which the checkbox 701 is set to “ON”. In Table 3, the key pair having the name “printer03-tls” and the usage TLS is added to the device 102, and TLS is deleted from the usage of the default key pair.

TABLE 3

| Name of key pair | Usage | Thumbmark of key pair |
|---|---|---|
| Default key pair | None | n/a |
| printer03-wifi | IEEE 802.1X | 51:25:BB:D5:D1:and so on |
| | | to:71:8C:FE:7C:5A |
| printer03-tls | TLS | DB:C3:AB:FA:13:and so on |
| | | to:67:ED:71:58:ED |

### Example 2

Next, a case in which the key pairs in Table 4 are instructed to be added to the device 102 (Table 1) will be described. Table 4 shows the key pairs instructed to be added to the device 102. The key pairs instructed to be added are two key pairs such as a key pair having the name “printer04-sip” and SIP set for the usage, and a key pair having the name “printer04-ipsec-sip” and IPSec and SIP set for the usage.

TABLE 4

| Name of key pair | Usage | Thumbmark of key pair |
|---|---|---|
| printer04-sip | SIP | 1A:B0:C9:94:E0:and so on |
| | | to:BE:77:65:B7:F8 |
| printer04-ipsec-sip | IPSec, SIP | 14:06:39:81:C3:and so on |
| | | to:90:7E:FB:4D:70 |

In the example of Table 4, since the usages “SIP” of the keys to be added overlap, the device management server 101 does not execute the addition processing through the processing of Step S802 and Step S803.

### Example 3

Table 5 shows the key pairs of the device 102 before addition. Two key pairs such as a default key pair and a key pair having the name “printer03-wifi-sip” are set in the device 102 before addition. TLS is set for the usage of the default key pair. IEEE 802.1X and SIP are set for the usage of printer03-wifi-sip.

TABLE 5

| Name of key pair | Usage | Thumbmark of key pair |
|---|---|---|
| Default key pair | TLS | n/a |
| printer03-wifi-sip | IEEE 802.1X, SIP | 6A:00:99:45:EF:13:and so on |
| | | to:A1:6D:A8:72:9D |

Table 6 shows the key pair instructed to be added to the device 102. The key pair instructed to be added has the name “printer03-ipsec-sip”, and IPSec and SIP are set for the usage.

TABLE 6

| Name of key pair | Usage | Thumbmark of key pair |
|---|---|---|
| printer03-ipsec-sip | IPSec, SIP | 1F:08:15:2A:54:34:and so on |
| | | to:DF:02:47:EE:75 |

A case in which the key pair shown in Table 6 is instructed to be added to the device 102 in which the key pairs shown in Table 5 are set will be described. First, a case in which the checkbox 701 in the setting screen for adding a key pair to a device (FIG. 7) is set to “OFF” will be described. If a key pair for the same usage is present in the device, and if it is set not to perform addition, since the key pair for the usage “SIP” is present in both the device and the key pair to be added, the device management server 101 does not perform the processing of adding a key pair. Next, a case in which the checkbox 701 in the setting screen for adding a key pair to a device (FIG. 7) is set to “ON” will be described. If the usage of the key pair to be added is prioritized, since the usage “SIP” is present in the key pair to be added, the device management server 101 deletes the usage SIP from the usage of the key pair having the name “printer03-ipsec-sip” set in the device 102. Table 7 shows settings of the key pairs of the device 102 after the addition processing in the case in which the checkbox 701 is set to “ON”. In Table 7, the key pair having the name “printer03-ipsec-sip” and the usages IPSec and SIP is added to the device 102, and SIP is deleted (canceled) from the usage of the key pair having the name “printer03-ipsec-sip”.

TABLE 7

| Name of key pair | Usage | Thumbmark of key pair |
|---|---|---|
| Default key pair | TLS | n/a |
| printer03-wifi-sip | IEEE 802.1X | 6A:00:99:45:EF:13:and so on |
| | | to:A1:6D:A8:72:9D |
| printer03-ipsec-sip | IPSec, SIP | 1F:08:15:2A:54:34:and so on |
| | | to:DF:02:47:EE:75 |

Next, processing in which the device management server 101 deletes a key pair from the device 102 will be described. FIG. 11 is a view showing an example of a setting screen for deleting a key pair from a device. The setting screen for deleting a key pair is a screen for settings of processing of deleting a key pair from the device 102 provided by the device management server 101. When a click on the execution button 404 is detected in a state in which “Delete key pair from device” is selected in the drop-down list 403 in the key pair management screen (FIG. 4), the device management server 101 displays the setting screen for deleting a key pair.

The setting screen for deleting a key pair includes a table 1001, a delete button 1002, and a cancel button 1003. The table 1001 is a table for selecting a key to be deleted and displays a list of key pairs registered in the device. The table 1001 displays checkboxes for selecting keys, names of keys, usages, subjects, and the numbers of registered devices. Since the key pairs displayed in the table 1001 are key pairs which are registered in the device, the table 1001 displays the key pairs in which the number of registered devices is one or larger. A user selects the key pairs to be deleted from the list of key pairs registered in the device displayed in the table 1001 and checks the corresponding checkboxes. When a user's click on the delete button 1002 is detected, the device management server 101 starts processing of deleting the selected key pairs with respect to each of the devices in which the key pairs whose checkboxes are selected in the table 1001 are registered. When a user's click on the cancel button 1003 is detected, the device management server 101 closes the setting screen for deleting a key pair.

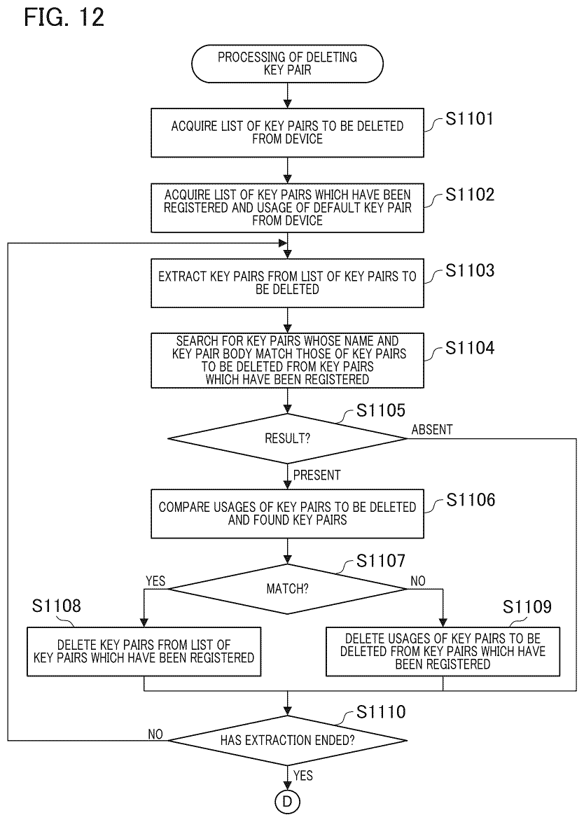

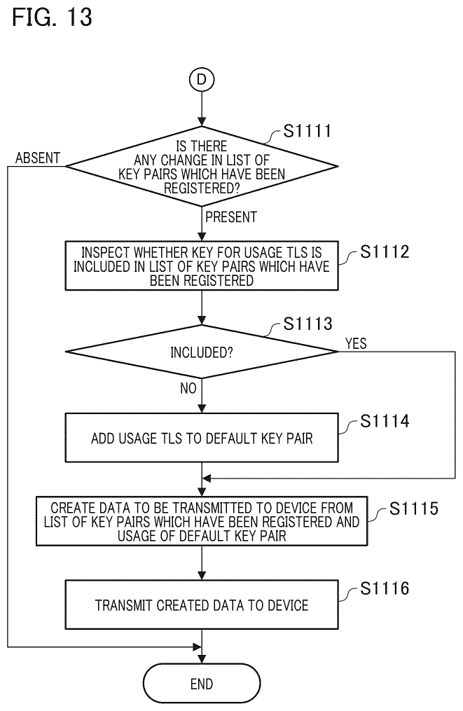

FIGS. 12 and 13 are flowcharts showing processing of deleting a key pair from a device. Here, a case in which the device management server 101 deletes a key pair from the device 102 will be described as an example. The processing of deleting a key pair by the device management server 101 is realized by the CPU 201 of the device management server 101 calling a program of the device management application from the memory (the ROM 203 or the external storage device 207) and executing it. Therefore, the CPU 201 of the device management server 101 functions as a deletion unit configured to delete a key pair from a device.

In Step S1101, the device management server 101 acquires a list of key pairs recorded as being registered in the device 102 from key pairs designated to be deleted from the table 1001 in the setting screen for deleting a key pair (FIG. 11). In Step S1102, the device management server 101 acquires key pair information (the usage of the default key pair and the list of key pairs which have been registered in the device 102) from the device 102.

In Step S1103, the device management server 101 extracts key pairs in order from the list of key pairs to be deleted acquired in Step S1101. The device management server 101 performs the processing of deleting a key pair in Step S1104 to Step S1109 for the extracted key pairs. In Step S1104, as deletion target key pairs which have been registered, the device management server 101 searches for key pairs whose body matches those of the name of the key pair to be deleted from the list of key pairs which have been registered in the device 102. In S1105, as a result of searching in S1104, the device management server 101 judges whether or not key pairs whose name and body match those of the key pairs to be deleted, which become the deletion target key pairs which have been registered, are found from the list of key pairs which have been registered in the device 102. If key pairs whose name and body match those of the key pairs to be deleted are not found, the device management server 101 performs the processing of Step S1110. On the other hand, if key pairs whose name and body match those of the key pairs to be deleted are found, the device management server 101 performs the processing of Step S1106.

In Step S1106, the device management server 101 compares the usages of the key pairs found through searching (deletion target key pairs which have been registered) with those of the key pairs to be deleted. In Step S1107, on the basis of the results of comparison in Step S1106, the device management server 101 judges whether or not the usages match. If the usages match, the device management server 101 performs the processing of Step S1108. On the other hand, if the usages do not match, the device management server 101 performs the processing of Step S1109.

In Step S1108, the device management server 101 deletes the found key pairs (deletion target key pairs which have been registered) from the list of key pairs which have been registered in the device 102. In Step S1109, the same usage as the usage of the key pair to be deleted in the usages of the found key pairs (deletion target key pairs which have been registered) is deleted from the list of key pairs which have been registered in the device 102. That is, in the list of key pairs which have been registered, only the usage of the key pair to be deleted is deleted from the usages of the key pairs whose name and body match those of the key pairs to be deleted (deletion target key pairs which have been registered), and the key pair body and the usages not included in the usage of the key pair to be deleted remain. For example, if the usage of the key pair to be deleted is “SIP” and the usages of the found key pairs (deletion target key pairs which have been registered) are “IEEE 802.1X” and “SIP”, and the usage “SIP” is deleted, and the usages of the deletion target key pairs which have been registered will be “IEEE 802.1X”.

In Step S1110, the device management server 101 judges whether deletion processing is performed with respect to all the key pairs instructed to be deleted acquired in Step S1101, that is, all the key pairs to be deleted is extracted in Step S1103. If deletion processing is performed with respect to all the key pairs instructed to be deleted, the processing of Step S1111 is performed. On the other hand, if deletion processing is not performed with respect to all the key pairs instructed to be deleted, that is, if any unextracted key pairs remain in the list of key pairs to be deleted, the processing returns to Step S1103.

In Step S1111, the device management server 101 checks the presence or absence of change with respect to the key pairs to be registered in the device 102. If there is no change, this denotes that key pairs designated to be deleted are not registered in the device 102, the device management server 101 ends the present processing. On the other hand, if there is change, that is, if a key pair or a usage is deleted from the list of key pairs which have been registered in the device 102, the device management server 101 performs the processing of Step S1112.

Regarding the usage of the key pair, there is a key pair for a predetermined usage that has to be always present in a device. Specifically, in the present embodiment, there is a restriction that it is necessary for the key pair for the usage TLS to be always present. In Step S1112, the device management server 101 checks whether a key pair for the usage TLS, which is a key pair for a predetermined usage that has to be always present in a device, is present in the list of key pairs which have been registered in the device 102. In Step S1113, as a result of checking in Step S1112, the device management server 101 judges whether or not the key pair for the usage TLS is present in the list of key pairs which have been registered. If the key pair for the usage TLS is present in the list of key pairs which have been registered, the device management server 101 performs the processing of Step S1115. On the other hand, if the key pair for the usage TLS is not present in the list of key pairs which have been registered, the device management server 101 performs the processing of Step S1114.

In Step S1114, the device management server 101 sets TLS for the usage of the default key pair and shifts to Step S1115. In Step S1115, registration instruction data to be transmitted to the device 102 is created from the list of registered key pairs and the usage of the default key pair. Finally, in Step S1116, the device management server 101 transmits the registration instruction data created in Step S1115 to the device 102. The device 102 which has received the registration instruction data from the device management server 101 sets the key pairs of the device 102 on the basis of the received registration instruction data. Accordingly, deletion of the key pairs from the device 102 is realized while complying with the restriction related to the key pairs. With this, the processing of deleting a key pair ends. After the processing of deleting a key pair has ended, the device management server 101 acquires the key pair information from the device 102 and updates the list of key pairs (the table 401) in the device management server 101 displayed in the key pair management screen (FIG. 4).

### Example 4

Table 8 shows the key pairs of the device 102 before deletion. Three key pairs such as a default key pair, a key pair having the name “printer03-wifi”, and a key pair having the name “printer03-ipsec” are set in the device 102 before deletion. TLS is set for the usage of the default key pair. IEEE 802.1X is set for the usage of printer03-wifi. In addition, the key pair body of printer03-wifi is set to KEY_III. IPSec is set for the usage of printer03-ipsec.

TABLE 8

| Name of key pair | Usage | Thumbmark of key pair |
|---|---|---|
| Default key pair | TLS | n/a |
| printer03-wifi | IEEE 802.1X | 12:48:A1:75:E9:and so on |
| | | to:9C:01:83:15:34 |
| printer03-ipsec | IPSec | BB:D5:D1:71:8C:and so on |
| | | to:FE:7C:5A:F7:9C |

Here, it is assumed that the key pair in Table 9 is instructed to be deleted. Table 9 shows the key pair instructed to be deleted from the device 102.

TABLE 9

| Name of key pair | Usage | Thumbmark of key pair |
|---|---|---|
| printer03-ipsec | IPSec | BB:D5:D1:71:8C:and so on |
| | | to:FE:7C:5A:F7:9C |

The key pair instructed to be deleted is a key pair having the name “printer03-ipsec”, the usage IPSec, and the key pair body KEY_III. The name and the body of the key pair instructed to be deleted match those of the third key pair in Table 8. In addition, the usage of the key pair instructed to be deleted also matches that of the third key pair in Table 8. When deletion processing of the key pair instructed to be deleted is executed, the key pair of the device 102 will become as shown in Table 9. Table 10 shows the key pairs of the device 102 after deletion. Table 10 is a result of deleting the third key pair from Table 8. In Example 4, since the key pair for the usage TLS is not the deletion target, the usage TLS is continuously set for the default key from before deletion.

TABLE 10

| Name of key pair | Usage | Thumbmark of key pair |
|---|---|---|
| Default key pair | TLS | n/a |
| printer03-wifi | IEEE 802.1X | 12:48:A1:75:E9:and so on |
| | | to:9C:01:83:15:34 |

### Example 5

Table 11 shows the key pairs of the device 102 before deletion. Three key pairs such as a default key pair, a key pair having the name “printer03-wifi”, and a key pair having the name “printer03-tls” are set in the device 102 before deletion. Nothing is set for the usage of the default key pair. IEEE 802.1X is set for the usage of printer03-wifi. TLS is set for the usage of printer03-tls. In addition, the key pair body of printer03-tls is set to KEY IV.

TABLE 11

| Name of key pair | Usage | Thumbmark of key pair |
|---|---|---|
| Default key pair | None | n/a |
| printer03-wifi | IEEE 802.1X | 12:48:A1:75:E9:and so on |
| | | to:9C:01:83:15:34 |
| printer03-tls | TLS | DB:C3:AB:FA:13:and so on |
| | | to:67:ED:71:58:ED |

Table 12 shows the key pair instructed to be deleted from the device 102. The key pair instructed to be deleted is a key pair having the name “printer03-tls”, the usage TLS, and the key pair body KEY_IV. The name and the body of the key pair instructed to be deleted match those of the third key pair in Table 11. In addition, the usage of the key pair instructed to be deleted also matches that of the third key pair in Table 11.

TABLE 12

| Name of key pair | Usage | Thumbmark of key pair |
|---|---|---|
| printer03-tls | TLS | DB:C3:AB:FA:13:and so on |
| | | to:67:ED:71:58:ED |

When deletion processing the key pair instructed to be deleted is executed, the key pair of the device 102 will become as shown in Table 13. Table 13 shows the key pairs of the device 102 after deletion. In Table 13, the third key in Table 10 is deleted, and TLS is added to the usage of the default key. In Example 5, since the key pair for the usage TLS is instructed to be deleted, the usage TLS is set for the default key pair.

TABLE 13

| Name of key pair | Usage | Thumbmark of key pair |
|---|---|---|
| Default key pair | TLS | n/a |
| printer03-wifi | IEEE 802.1X | 12:48:A1:75:E9:and so on |
| | | to:9C:01:83:15:34 |

### Example 6

Table 14 shows the key pairs of the device 102 before deletion. Three key pairs such as a default key pair, a key pair having the name “printer03-wifi”, and a key pair having the name “printer03-tls” are set in the device 102 before deletion. Nothing is set for the usage of the default key pair. IEEE 802.1X and IPSec are set for the usage of printer03-wifi. TLS is set for the usage of printer03-tls. In addition, the key pair body of printer03-tls is set to KEY III.

TABLE 14

| Name of key pair | Usage | Thumbmark of key pair |
|---|---|---|
| Default key pair | None | n/a |
| printer03-wifi | IEEE 802.1X, | 12:48:A1:75:E9:and so on |
| | IPSec | to:9C:01:83:15:34 |
| printer03-tls | TLS | DB:C3:AB:FA:13:and so on |
| | | to:67:ED:71:58:ED |

Table 15 shows the key pair instructed to be deleted from the device 102. The key pair instructed to be deleted is a key pair having the name “printer03-wifi”, the usage IEEE 802.1X, and the key pair body KEY_III. The name and the body of the key pair instructed to be deleted match those of the second key pair in Table 14. IEEE 802.1X and IPSec are set for the usage of the second key pair in Table 14, but the usage instructed to be deleted is only IEEE 802.1X of these. For this reason, the usage “IEEE 802.1X” is deleted from the key pair, and the key pair printer03-wifi having the usage IPSec remains. A difference occurs between the usage of the key pair instructed to be deleted with matching name and body (the key pair in the device management server 101) and the usage of the key pair set in the device, for example, if a user sets the usage of the key pair using the panel of the device or the WEB_III. Since a user has added IPSec to the usage of printer03-wifi using the panel or the like of the device 102, a difference occurs between the key pair in the device management server 101 (only “IEEE 802.1X” is set for the usage) and the key pair in the device.

TABLE 15

| Name of key pair | Usage | Thumbmark of key pair |
|---|---|---|
| printer03-wifi | IEEE 802.1X | 12:48:A1:75:E9:and so on |
| | | to:9C:01:83:15:34 |

When deletion processing of the key pair instructed to be deleted is executed, the key pairs of the device 102 will become as shown in Table 16. Table 16 shows the key pairs of the device 102 after deletion. In Table 16, the usage IEEE 802.1X is deleted from the second key in Table 14. In Example 15, since the key pair for the usage TLS is not the deletion target, the usage TLS is continuously set for printer03-tls from before deletion.

TABLE 16

| Name of key pair | Usage | Thumbmark of key pair |
|---|---|---|
| Default key pair | None | n/a |
| printer03-wifi | IPSec | 12:48:A1:75:E9:and so on |
| | | to:9C:01:83:15:34 |
| printer03-tls | TLS | DB:C3:AB:FA:13:and so on |
| | | to:67:ED:71:58:ED |

As described above, according to the present embodiment, when a key pair is added, a selection as to whether or not to perform overwriting is received if a key pair for the same usage is present. Therefore, if overwriting is selected, a key pair can be added even if a key pair for the same usage is already present. When overwriting is performed by adding a key pair, a key pair for the same usage can be prevented from being set in the device by deleting the same usage as the usage of the key pair to be added from the existing key pair. In addition, when a key pair is deleted, if the key for a predetermined usage (for example, the usage TLS) that has to be always present in the device is deleted, the key pair for a predetermined usage can be always present in the device by setting a predetermined usage in the default key.

### Second Embodiment

When a plurality of key pairs are added to a device, a plurality of key pairs having the same name and key pair body may be present in the list of key pairs to be added. In addition, a plurality of key pairs having the same name and key pair body may be present in the list of key pairs registered in the device. Such a plurality of key pairs can be integrated into one key pair having the name and the key pair body with the union of the usages of the key pairs as its usage. In the present embodiment, integration of key pairs will be described.

Here, a specific scene in which integration processing of key pairs is executed will be described. First, utilization of integration processing of the list of key pairs in the processing of adding a key pair will be described. When the list of key pairs to be added in the processing of adding a key is acquired, the device management server 101 performs integration of the list of key pairs to be added (Step S801). In addition, the device management server 101 executes the integration processing instead of duplicating the list of key pairs of devices (Step S901). Further, the device management server 101 handles the list of key pairs after integration in Step S901 as the list of key pairs to be registered. Next, utilization of the integration processing of the list of key pairs in the processing of deleting a key pair will be described. The device management server 101 executes the integration processing with respect to the list of key pairs acquired from the device and uses the list after integration as the list of key pairs which have been registered (Step S1102).

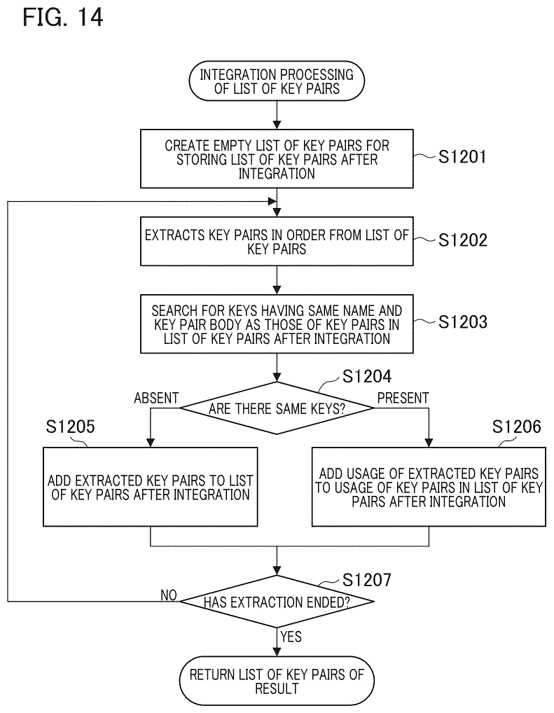

FIG. 14 is a flowchart showing integration processing of a list of key pairs. The integration processing of a list of key pairs by the device management server 101 is realized by the CPU 201 of the device management server 101 calling a program of the device management application from the memory (the ROM 203 or the external storage device 207) and executing it.

When the integration processing of a list of key pairs starts, a list of key pairs to be integrated is input to the device management server 101. In Step S1201, the device management server 101 creates an empty list of key pairs for storing the list of key pairs after integration. Next, in Step S1202, the device management server 101 extracts key pairs in order from the list of key pairs that is the input integration target. The device management server 101 performs the processing of Step S1203 to Step S1206 with respect to the extracted key pairs.

In Step S1203, the device management server 101 searches for key pairs having the same name and key pair body as those of the extracted key pairs from the list of key pairs after integration. In Step S1204, as a result of searching in Step S1203, the device management server 101 judges whether key pairs having the same name and key pair body are found. As a result of the searching, if the key pairs having the same name and key pair body are not found, the device management server 101 performs the processing of Step S1205. On the other hand, as a result of the searching, if the key pairs having the same name and key pair body are found, the device management server 101 performs the processing of Step S1206.

In Step S1205, the device management server 101 adds the extracted key pairs to the list of key pairs after integration. In Step S1206, the device management server 101 adds the usages of the extracted key pairs to the usages of the key pairs in the list of key pairs after integration. If there is no usages to be added, that is, if the usages of the extracted key pairs and the usages of the key pairs in the list of key pairs after integration are the same, the device management server 101 adds no usages. In Step S1107, the device management server 101 checks whether processing with respect to all the key pairs to be integrated in the list of key pairs has ended. If the processing with respect to all the key pairs to be integrated in the list of key pairs has ended, that is, if all the key pairs to be integrated in the list of key pairs have been extracted in Step S1202, the processing of Step S1208 is performed. On the other hand, if the processing with respect to all the key pairs to be integrated in the list of key pairs has not ended, the processing returns to Step S1202. In Step S1208, the device management server 101 returns the list of key pairs after integration to the calling side and ends the processing.

Table 17 shows a list of key pairs to be integrated. The list of key pairs instructed to be integrated includes two key pairs having the name “printer05-one” and one key pair having the name “printer05-two”. IEEE 802.1X and IPSec are set for the usage of the first key pair “printer05-one”. IEEE 802.1X and SIP are set for the usage of the second key pair “printer05-one”. TLS is set for the usage of the key pair “printer05-two”.

TABLE 17

| Name of key pair | Usage | Thumbmark of key pair |
|---|---|---|
| printer05-one | IEEE 802.1X, | 1B:12:F5:E0:B7:and so on |
| | IPSec | to:FC:29:37:17:02 |
| printer05-one | IEEE 802.1X, SIP | 1B:12:F5:E0:B7:and so on |
| | | to:FC:29:37:17:02 |
| printer05-two | TLS | D9:22:D6:A3:CB:and so on |
| | | to:C9:6A:24:5B:A0 |

When the integration processing is executed with respect to the list of Table 17, the list of Table 18 is obtained. Table 18 shows the list of key pairs after integration processing. As a result of the integration processing, the key pair having the name “printer05-one” is integrated. Three usages IEEE 802.1X, IPSec, and SIP are set for the usage of the key pair printer05-one.

TABLE 18

| Name of key pair | Usage | Thumbmark of key pair |
|---|---|---|
| printer05-one | IEEE 802.1X, | 1B:12:F5:E0:B7:and so on |
| | IPSec, SIP | to:FC:29:37:17:02 |
| printer05-two | TLS | D9:22:D6:A3:CB:and so on |
| | | to:C9:6A:24:5B:A0 |

As above, according to the present embodiment, the device management server 101 can perform the integration processing with respect to the list of key pairs to be added and the list of key pairs registered in the device. By integrating the list of key pairs, the number of steps of processing thereafter in searching processing and the like can be reduced.

### OTHER EMBODIMENTS

Embodiment(s) of the present invention can also be realized by a computer of a system or apparatus that reads out and performs computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and perform the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-002865 filed Jan. 11, 2024, which is hereby incorporated by reference wherein in its entirety.

What is claimed is:

1. A device management apparatus managing key pairs set in management target network devices via a network, the device management apparatus comprising:
a memory storing instructions; and
a processor executing the instructions causing the device management apparatus to:
receive a selection as to whether or not to perform overwriting with a key pair instructed to be added to a network device if a key pair for the same usage as the usage of the key pair instructed to be added has already been set in the network device; and
delete the same usage as that of a key pair instructed to be added from the usage of the key pair set in the network device and add the key pair instructed to be added if a selection to perform overwriting with the key pair instructed to be added has been received.

2. The device management apparatus according to claim 1,
wherein the processor acquires the usage of a default key and a list of registered key pairs in the network device from the network device, creates a list of key pairs to be registered in the network device on the basis of the acquired list of registered key pairs in the network device, and adds the key pair instructed to be added to the created list of key pairs to be registered,
if a selection to perform overwriting with a key pair instructed to be added has been received, the processor deletes the same usage as the usage of the key pair instructed to be added from the usage of the key pair and the usage of the default key set in the network device in the list of key pairs to be registered, and
the processor creates registration instruction data of key pairs on the basis of the list of key pairs to be registered and the usage of the default key, and adds a key pair by transmitting the registration instruction data to the network device.

3. The device management apparatus according to claim 2,
wherein the processor checks whether there is a key pair for a predetermined usage that has to be always present in the network device in the list of key pairs to be registered after the same usage as the usage of the key pair instructed to be added is deleted, and adds a predetermined usage to the usage of the default key if there is no key pair for the predetermined usage.

4. The device management apparatus according to claim 3,
wherein the key pair is a key pair of a public key and a secret key for encrypting communication, and
the predetermined usage of a key pair is a usage used by the network device for transport layer security (TLS).

5. The device management apparatus according to claim 1,
wherein the network device is an image forming device.

6. The device management apparatus according to claim 1,
wherein the processor performs display for allowing a user to select whether or not to perform overwriting if a key pair for the same usage as the usage of a key pair instructed to be added is present on a screen for setting addition of a key pair to a network device, and
if a key pair for the same usage is present in the key pair instructed to be added, the processor does not add the key pair instructed to be added.

7. A device management apparatus managing key pairs set in management target network devices via a network, the device management apparatus comprising:
a memory storing instructions; and
a processor executing the instructions causing the device management apparatus to:
delete a key pair instructed to be deleted from a network device,
wherein if a key pair for a predetermined usage that has to be always present in the network device is deleted, the processor adds the predetermined usage to the usage of a default key of the network device.

8. The device management apparatus according to claim 7,
wherein the processor acquires the usage of the default key and a list of registered key pairs in the network device from the network device,
if there is a key pair whose name and body match those of the key pair instructed to be deleted in the list of registered key pairs, the processor deletes the key pair from the list of registered key pairs if the usage of the key pair matches that of the key pair instructed to be deleted, and deletes only the same usage as the usage of the key pair instructed to be deleted from the usage of the key pair in the list of registered key pairs if the usage of the key pair does not match that of the key pair instructed to be deleted, if there is no key having a predetermined usage in the list of registered key pairs, the processor adds the predetermined usage to the usage of the default key of the network device, and
the processor creates registration instruction data of key pairs on the basis of the list of registered key pairs and the usage of the default key, and deletes a key pair by transmitting the registration instruction data to the network device.

9. The device management apparatus according to claim 7,
wherein the key pair is a key pair of a public key and a secret key for encrypting communication, and
the predetermined usage of a key pair is a usage used by the network device for transport layer security (TLS).

10. A control method of a device management apparatus managing key pairs set in management target network devices via a network, the method comprising:
receiving a selection as to whether or not to perform overwriting with a key pair instructed to be added to a network device if a key pair for the same usage as the usage of the key pair instructed to be added has already been set in the network device; and
deleting the same usage as that of a key pair instructed to be added from the usage of the key pair set in the network device and adding the key pair instructed to be added if a selection to perform overwriting with the key pair instructed to be added has been received.

11. A control method of a device management apparatus managing key pairs set in management target network devices via a network, the method comprising:
deleting a key pair instructed to be deleted from a network device,
wherein if a key pair for a predetermined usage is deleted, the predetermined usage is added to the usage of a default key of the network device.

12. A non-transitory storage medium storing a control program of a device management apparatus managing key pairs set in management target network devices via a network causing a computer to perform each step of a control method of the device management apparatus, the method comprising:
receiving a selection as to whether or not to perform overwriting with a key pair instructed to be added to a network device if a key pair for the same usage as the usage of the key pair instructed to be added has already been set in the network device; and
deleting the same usage as that of a key pair instructed to be added from the usage of the key pair set in the network device, and adding the key pair instructed to be added if a selection to perform overwriting with the key pair instructed to be added has been received.

13. A non-transitory storage medium storing a control program of a device management apparatus managing key pairs set in management target network devices via a network causing a computer to perform each step of a control method of the device management apparatus, the method comprising:
deleting a key pair instructed to be deleted from a network device,
wherein if a key pair for a predetermined usage is deleted, the predetermined usage is added to the usage of a default key of the network device.
